(19) United States
(12) Patent Application Publication
(10) Pub. No.: US 2008/0060238 A1
(43) Pub. Date: Mar. 13, 2008

(54) Neon simulated phosphor illumination sign

(76) Inventors: John Chiang, Oceanside, CA (US); Ken-Sheng Chiang, Oceanside, CA (US)

Correspondence Address: Raymond Y. Chan;Suite 128, 108 N. Ynez Avenue, Monterey Park, CA, 91754, US

(21) Appl. No.: 11/811,237

(22) Filed: Jun. 7, 2007

Related U.S. Application Data
(63) Continuation-in-part of application No. 11/786,966, filed on Apr. 13, 2007.
(60) Provisional application No. 60/843,459, filed on Sep. 8, 2006.

(51) Int. Cl. G09F 13/04

(52) U.S. Cl. 40/564

(57) ABSTRACT

A neon simulated illumination sign has a base housing and a display panel made of light transmitting material, with a displaying side and an attachment side. The base housing houses light sources while the display panel has a background portion that is preferably a flat surface and a protruding portion that forms sign characters, wherein a lighting blocking layer coated to the background portion of the display panel, and a highlight coating coated on said protruding portion of the attachment side of the display panel. Light can go through the protruding portion with a highlight coating. The illumination sign includes one or more through openings which are designed to create a wide variety of three dimensional features which are more outstanding than that in conventional illumination signs.

### CROSS REFERENCE TO RELATED APPLICATIONS

This is a CIP application of a non-provisional application, having an application Ser. No. 11/786,966, and a filing date of Apr. 13, 2007, which is a non-provisional application of a provision application having an application Ser. No. of 60/843,459 and a filing date of Sep. 08, 2006.

### BACKGROUND OF THE PRESENT INVENTION

1. Field of Invention

The present invention relates to a sign, and more particularly to an illumination sign which is capable of simulating a typical neon illumination sign and avoiding the harmful effect and limitations thereof.

2. Description of Related Arts

Conventional neon illumination signs usually use argon based tubes as light source. The argon based tubes usually have mercury inside which may be harmful to the environment as well as the user when leakage occurs. Moreover, conventional neon illumination consumes more energy. As a result, LED illumination signs become more preferable and seem to be a perfect substitute for conventional neon illumination signs. Generally speaking, LED illumination produces intense illumination with less energy consumption and avoids harmful effect to the environment.

Many kinds of phosphor exist in the market today but in the present invention ultraviolet ray phosphor is preferred. The ultraviolet ray phosphor is fully activated only when impinged by ultraviolet rays. This is the working principle of color-selected LED illumination in the present invention in which unique look of phosphorus coated panels can be achieved.

Plastic forming technology employed on these signs is also important in the present invention. After the process with vacuum forming, the edges of plastics are usually rough and jagged, and subsequent coating or painting thereon becomes relatively difficult because the surface is uneven. To solve this problem, laser cutting technology is therefore applied. Laser cutting is famous for its preciseness, cleanness and silent. The plastic is processed based on the design programmed into the laser cutting machine and the edges of the plastic are much smoother than that after vacuum forming process, and the problem of subsequent coating or painting on uneven plastic surfaces is thus resolved.

As an alternative to neon signs, the illumination sign in the present invention is advantageous because it is light, invulnerable, easy to carry and consuming less power. More importantly, from the environmental point of view, there is no harmful substance in the present invention, such as argon gas or mercury, as compared to argon based neon tubes. In other words, conventional neon illumination signs contain harmful substance which causes potential danger to the users as well as the environment. Moreover, the manufacturing process of conventional neon illumination signs is complicated and expensive.

From the aesthetic point of view, some conventional illumination signs are hung on the wall and the sign characters on the illumination signs are not standing out from the background. Less attractive illumination signs may be harmful to business. The illumination signs in the present invention comprise one or more through openings which can not only make the sign characters more outstanding, but also attract more people when they can see through the illumination signs hung in the store from the through openings.

### SUMMARY OF THE PRESENT INVENTION

A main object of the present invention is to provide a simulated neon illumination sign, wherein the illumination sign has one or more through openings designed to create a wide variety of three dimensional features which are more outstanding than that in conventional illumination signs.

Another object of the present invention is to provide a simulated neon illumination sign which comprises a display and a base panel both made by plastic. The display and the base panels can be snap fit firmly either by the clasps formed in both panels, or by using adhesive glue or screws in multiple engaging edges of the panels.

Another object of the present invention is to provide a simulated neon illumination sign which is structurally simple, inexpensive, and without utilizing anything that may be harmful to the environment, such as argon gas or mercury.

Another object of the present invention is to provide a simulated neon illumination sign, wherein the illumination sign could be utilized in a wide variety of circumstances for providing high quality illumination of predetermined sign characters. Moreover, the present invention is capable of utilizing a wide variety of light sources for providing illumination of sign characters.

Accordingly, in order to accomplish the above objects, the present invention provides a simulated neon illumination sign, comprising:

a display panel, which has an attachment side and a displaying side having a flat background portion provided thereon, having one or more contour openings each defining an inner contour edge, and a plurality of protruding portions protruded from the front panel to form a corresponding number of character signs at the displaying side of the display panel, wherein the display panel has a predetermined light admissibility for allowing light to pass therethrough;

a base panel which has one or more boundary openings aligned with the contour openings in the display panel and a backlight arrangement for providing illumination to the display panel, wherein the backlight arrangement comprises a light box mounted at the attachment side of the display panel and a plurality of illuminators which are spacedly placed within the light box and are electrically connected to a circuit control for generating the light towards the display panel; and

a highlighting element provided at the attachment side of the display panel and arranged in such a manner that when the light passes through the protruding portions of the display panel, the highlighting element creates a neon illuminating effect at the protruding portions thereof, such that the character signs are illuminated at the display panel through the protruding portions for simulating a three dimensional neon illumination effect.

These and other objectives, features, and advantages of the present invention will become apparent from the following detailed description, the accompanying drawings, and the appended claims.

### BRIEF DESCRIPTION OF THE DRAWINGS

FIG. 1 is a front view showing the illumination sign according to a preferred embodiment of the present invention.

FIG. 2 is a rear view of the illumination sign according to the above preferred embodiment of the present invention.

FIG. 3 is a front perspective view of the illumination sign according to the above preferred embodiment of the present invention.

FIG. 4 is a rear perspective view of the illumination sign according to the above preferred embodiment of the present invention.

FIG. 5 is a sectional side view of the illumination sign according to the above preferred embodiment of the present invention.

FIG. 6 is an exploded view of the illumination sign according to the above preferred embodiment of the present invention.

FIG. 7 is a schematic view of the illumination sign according to the above preferred embodiment of the present invention.

FIG. 8 is a front view of a neon simulated illumination sign according to a second preferred embodiment of the present invention.

FIG. 9 is a sectional side view of the neon simulated illumination sign according to the above second preferred embodiment of the present invention.

FIG. 10 is an enlarged sectional side view of the neon simulated illumination sign according to a second preferred embodiment of the present invention, illustrating the snap fit engagement between the display panel and the base housing.

FIG. 11 is an exploded perspective view of the neon simulated illumination sign according to a second preferred embodiment of the present invention.

FIG. 12 illustrates an alternative mode of the neon simulated illumination sign according to a second preferred embodiment of the present invention.

### DETAILED DESCRIPTION OF THE PREFERRED EMBODIMENT

Throughout the following detailed description, the same reference numerals refer to the same elements in all figures.

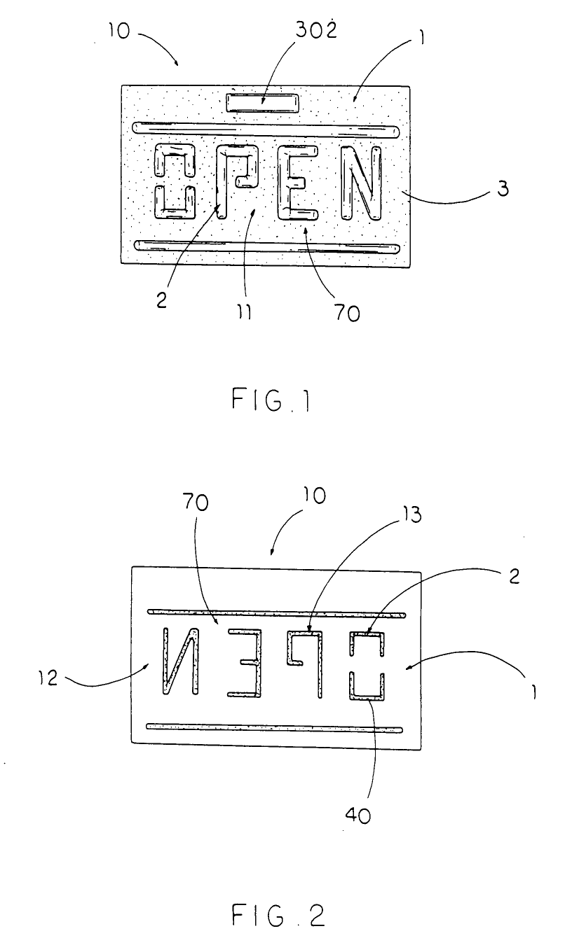

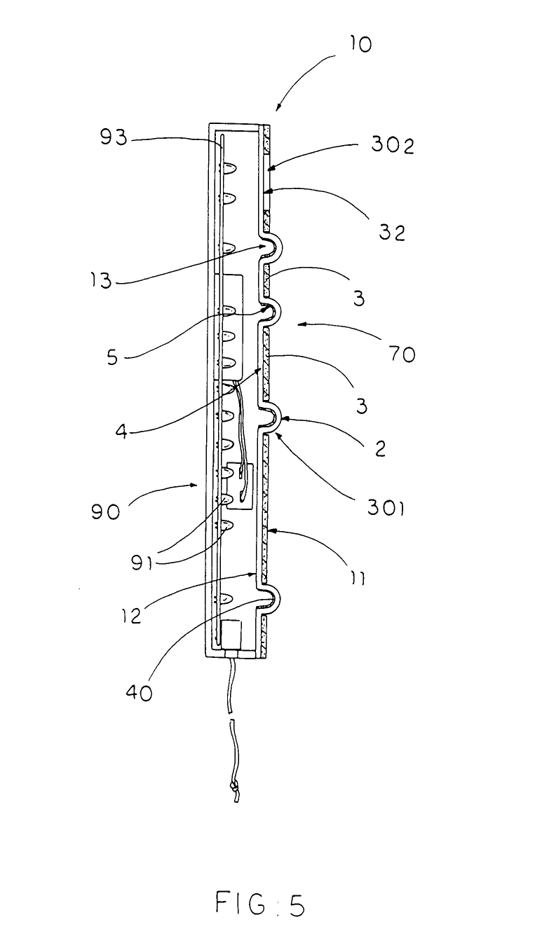

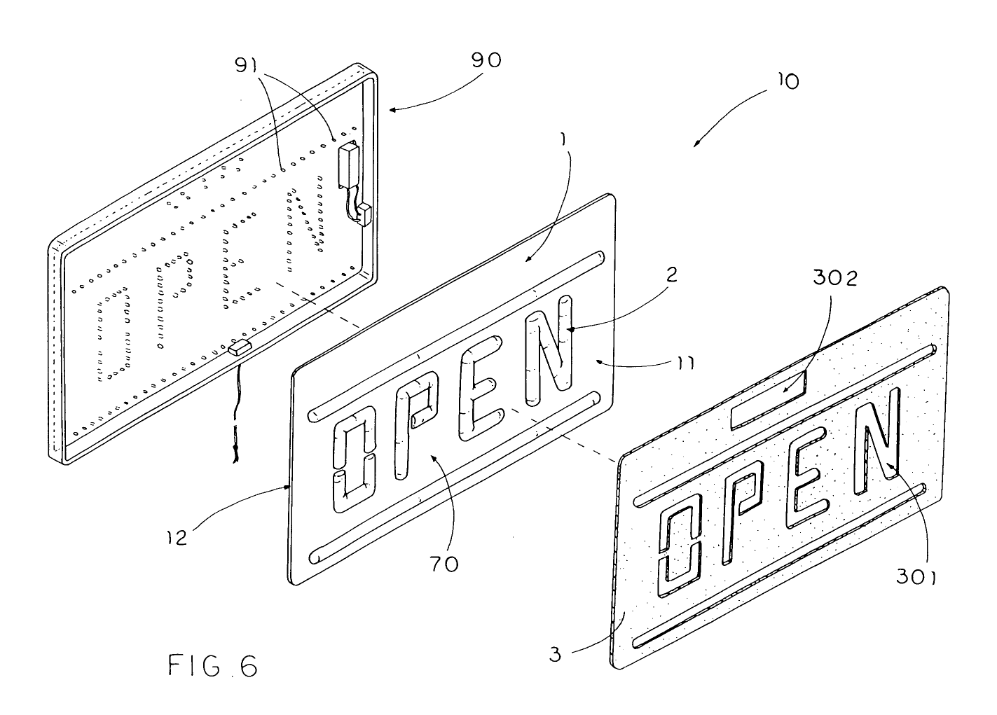

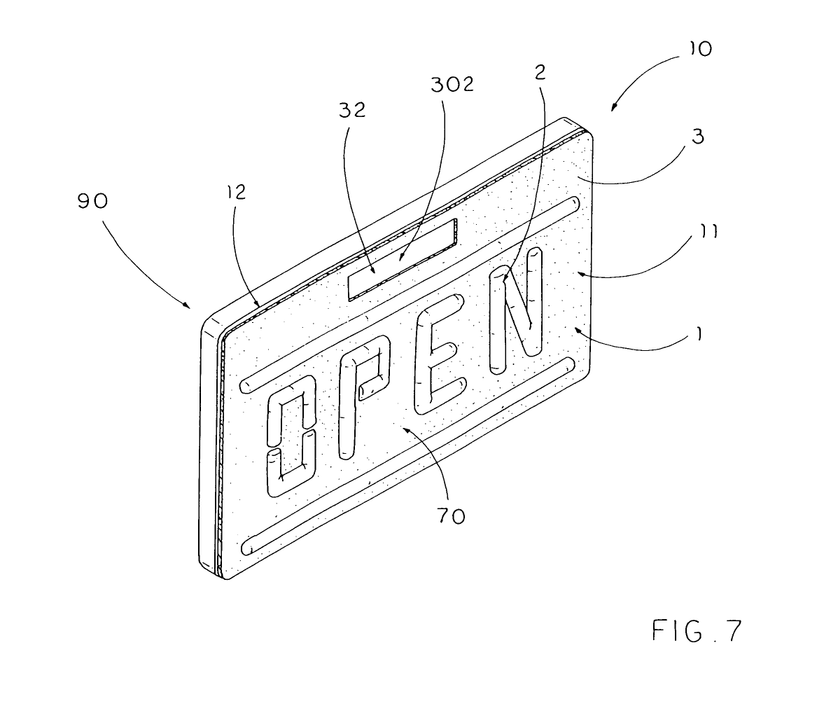

Referring to FIG. 1, FIG. 2 and FIG. 5, a sign panel 10, made of light transmitting material, has a front displaying side and a rear side. The sign panel 10 has a background portion 1 that is preferably a flat surface, a protruding portion 2 that forms sign characters 70, a light blocking layer 3 attached to said background portion 1 of the sign panel 10, a highlighting element 40 and a highlight coating 5 coated on the protruding portion 2 of the rear side of the sign panel 10.

Furthermore, as shown in FIG. 1 and FIG. 5, the background portion 1 of the front displaying side of the sign panel 10 is coated with a black color blocking layer 3 so that the light can not go though the background portion 1, and the protruding portion 2 of the front displaying side of the sign panel 10 forms sign characters.

As shown in FIG. 2 and FIG. 5, the rear side of the sign panel 10 is coated with a red color layer 4 so that the light can not go though the background portion 1, and the protruding portion 2 of the rear side of the sign panel 10 is protruding to the front displaying side. A highlight coating 5 with different colors can be coated on the protruding portion 2 of the rear side of the sign panel 10 to create a neon illuminating effect when the light projects thereto or from the rear side of the sign panel 10.

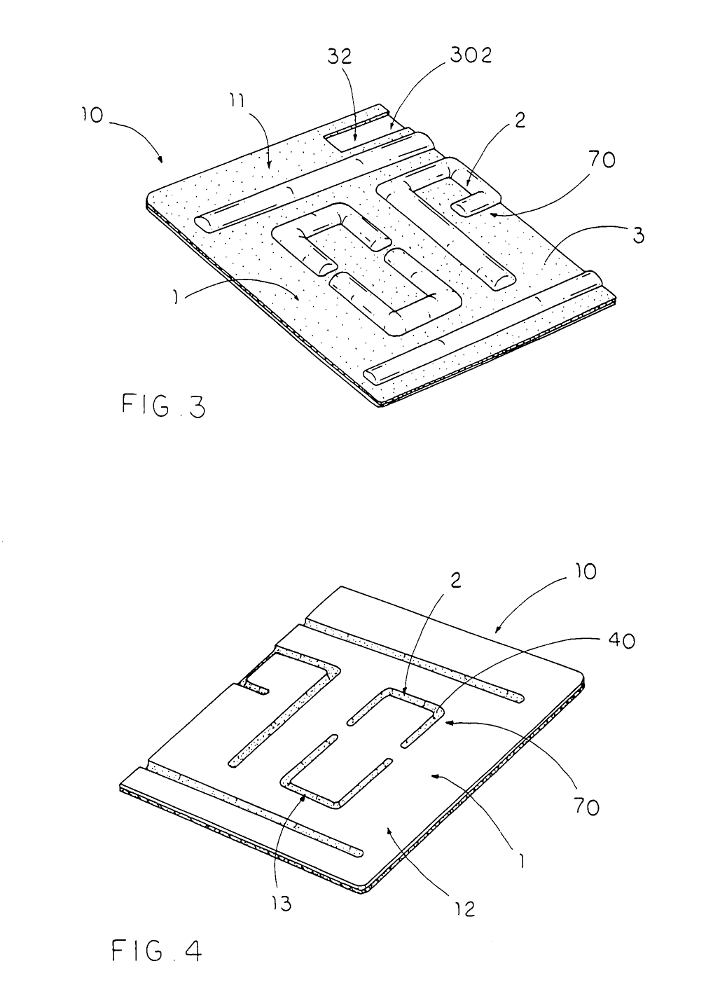

As shown in FIG. 3 and FIG. 4, the sign panel 10 made of light transmitting material (either transparent or translucent material) for light passing from one side to the opposed side. The protruding portion 2 of the sign panel 10 has a curved cross section made by plastic injection and the cross section of the protruding portion 2 presents semi-circle. Light can go through the protruding portion 2 and make the protruding portion 2 looks like sign characters.

After the process with vacuum forming, the edges of plastic are usually rough and jagged, and subsequent coating or painting thereon becomes relatively difficult because the surface is uneven. To solve this problem, laser cutting technology is applied. Laser cutting is famous for its preciseness, cleanness and silent. The plastic is processed based on the design programmed into the laser cutting machine and the edges of the plastic are much smoother than that after vacuum forming process, and the problem of coating or painting on uneven plastic surfaces is thus resolved.

Referring to FIG. 6, a light box 90 houses light source therein and electrically connects to a power source. The light source can be a plurality of LEDs, or conventional fluorescent light tubes to generate the light towards the rear side of the sign panel 10. For LED configuration, a circuit board is required to electrically connect and support the LEDs in the light box. In addition, the LEDs are aligned with the grooves on the rear side of the sign characters 70.

In a preferred embodiment, the simulated neon illumination sign comprises the sign panel 10 with the sign characters 70 and the light box 90 which provides light for the sign panel 10, wherein the sign panel is a board made of light transmitting material with the background portion and the protruding portion, while the light box 90 has the light source therein electrically connected to a power source and the light source generates the light towards the rear side of the sign panel 10.

The sign panel 10 made of light transmitting material (either transparent or translucent material) for light passing from one side to the opposed side. The background portion 1 of the sign panel 10 is preferably a flat surface with the blocking layer 3. The blocking layer is coated on either one or both sides of the background portion of the sign panel 10. A light blocking coating can be further coated at the rear side of the sign panel 10. The purpose of using the blocking layer and coating is to block the light from the light box passing through so as to define the sign characters at the protruding sign portion. The protruding portion of the sign panel 10 has a curved cross section formed by plastic injection. The cross section of the protruding portion of the sign panel 10 is semi-circle (or other shape if any). A highlight coating with different colors can be coated on the rear side of the protruding portion of the sign panel 10 to create neon illuminating effect when the light projects thereto or from the rear side of the sign panel 10.

The light blocking layer 3, which is overlappedly mounted on the front displaying side 11 of the sign panel 10 at the background portion 1 thereof, has a plurality of through shaping slots 301 shaped corresponding to the protruding portions 2 of the sign panel 10, wherein when the light blocking layer 3 is overlapped on the front displaying side 11 of the sign panel 10, the protruding portions 2 of the sign panel 10 are projected through the shaping slots 301, such that the light blocking layer 3 is only overlapped on the background portion 1 of the sign panel 10 for blocking the light from passing through the background portion 1 of the sign panel 10.

The highlighting element 40 is provided at the rear side 12 of the sign panel 10 and arranged in such a manner that when the light passes through the protruding portions 2 of the sign panel 10, the highlighting element 40 generates neon illuminating effect at the protruding portions 2 of the sign panel 10, such that the character signs 70 are illuminated at the front displaying side 11 of the sign panel 10 through the protruding portions 2 for simulating a three dimensional neon illumination effect of the sign panel 10. The highlighting element 40 is preferably ultraviolet ray phosphor coating coated on the rear side 12 of the sign panel 10.

According to the preferred embodiment of the present invention, the sign panel 10 is shaped and crafted to have a predetermined shape as a shape of the illumination sign which is to be displayed at a predetermined position. The sign panel 10 is made of light-admissible material so that when light passes through the sign panel 10, the sign panel 10 will be illuminated from the front displaying side 11 thereof.

The protruding portions 2 are formed on the front displaying side 11 of the sign panel 10 for forming a plurality of character signs 70 thereon. Accordingly, the sign panel 10 further has a corresponding number of channels 13 indently formed at a rear side 12 of the sign panel 10 for forming the protruding portions 2 at the front displaying side 11. It is worth mentioning that the shape of each of the channels 13 constitutes the contour of the corresponding character sign 70 so that the character signs 70 can be easily produced during the manufacturing process by pressing the channel 13 on the sign panel 10 or by making the sign panel 10 by conventional molding techniques.

It is worth mentioning that the light blocking layer 3 comprises a light inadmissible coating for blocking light from passing through the background portion 1 of the sign panel 10. According to the preferred embodiment of the present invention, the light blocking layer 3 comprises a black-colored light inadmissible coating for blocking light passing therethrough, and contrasting with the protruding portions 2 of the sign panel 10 so as to optimally highlight the character signs 70 at the front displaying side 11 of the sign panel 10.

Moreover, the light blocking layer 3 further has at least a through decorative slot 302 formed thereon and arranged when the light blocking layer 3 is overlappedly mounted on the front displaying side 11 of the sign panel 10 at the background portion 1 thereof, the sign panel 10 further forms a decorative portion 32 within the background portion 1 thereof through the decorative slot 302 such that not only the character signs 70 but also the decorative portion 32 are illuminated at the front displaying side 11 of the sign panel 10 for simulating the neon illumination effect of the sign panel 10. The decorative portion 32 therefore forms a decorative pattern on the sign panel 10.

In order to strengthen the illumination effect of the sign characters 70, each of the protruding portions 2 of the sign panel 10 has a curved cross section integrally protruding from the flat background portion 1 of the sign panel 10 at the front displaying side 11 thereof to create the sign character 70 in a three dimension manner.

The operation of the present invention is as follows: the illumination sign is erected or supporting in front of a light source, such as a conventional light box 90. When light passes through the illumination sign, only those portion of light which impinges on the protruding portion 2 of the sign panel 10 and the decorative portion 32 is allowed to penetrate the entire illumination sign so that the character signs 70 and the decorative patterns are lit up by the light source to produce a three-dimensional illumination at the illumination sign. It is particularly important to note that the present invention is capable of producing illumination of character signs 70 and decorative patterns having three-dimensional illumination performance without utilizing any harmful substances, such as argon gas or mercury.

Hence, it is important to mention that the present invention may well be incorporated with a light source, which may be embodied as a light box 90 comprising a plurality of LEDs 91 emitting illumination of a predetermined color, mounted at the rear side 12 of the sign panel 10 so as to produce the neon illumination effect at the character signs 70 and the decorative patterns of the illumination sign of the present invention.

In other words, the illumination sign further comprises a backlight arrangement for providing illumination to the sign panel 10, wherein the backlight arrangement comprises a light box 90 mounted at the rear side 12 of the sign panel 10 and a plurality of illuminators embodying as LEDs 91 which are spacedly supported within the light box 90 and are electrically connected to a circuit control 93 for generating the light towards the sign panel 10. Each of the LEDs generates light with a wave length matching an ultraviolet wave length of the ultraviolet ray phosphor coating (i.e. highlighting element 40) on the sign panel 10.

One common concern regarding conventional neon signs is the use of harmful substances such as mercury or argon. The present invention completely gets rid of this requirement in that the light source of the illumination sign can be LEDs 90, which is diode with specific crystals.

Moreover, it is important to state that the sign panel 10 is arranged to be cut with laser so that it will have precise shape and smooth edges.

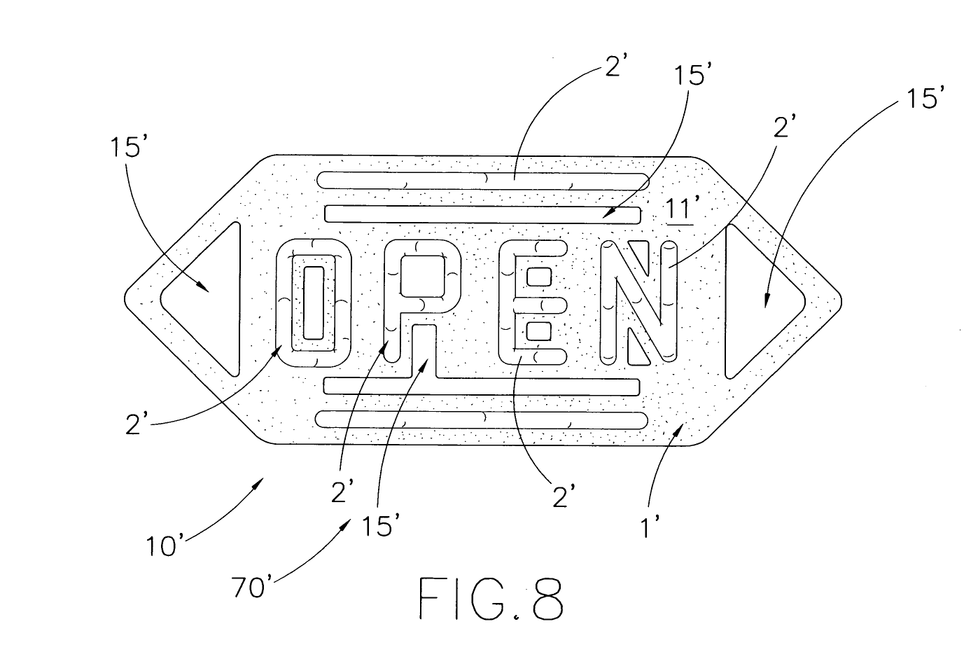

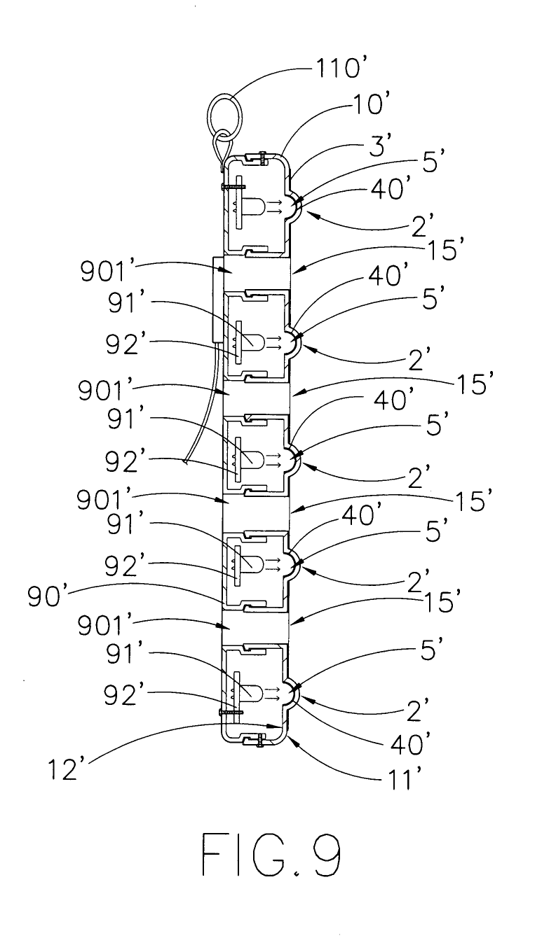

As shown in FIGS. 8 to 11, a simulated neon illumination sign of a second embodiment illustrates an alternative mode of the first embodiment of the present invention. Accordingly, the simulated neon illumination sign comprises a display panel 10′, a base housing 90′, and a highlighting element 40′.

The display panel 10′ has an attachment side 12′, an opposed displaying side 11′, a background portion 1′ for blocking light passing through display panel from the attachment side 12′ to the displaying side 11′, one or more contour openings 15′ spacedly formed at the background portion 1′ for communicating the attachment side 12′ with the displaying side 11′, and a plurality of protruding portions 2′ protruded from the displaying side 11′ to form a corresponding number of character signs 70′ at the displaying side 11′, wherein the protruding portions 2′ is adapted for the light passing through display panel 10′ from the attachment side 12′ to the displaying side 11′.

Accordingly, each of the protruding portions 2′ of the display panel 10′ has a curved cross section integrally protruding from the background portion 1′ of the displaying side 11′ of the display panel 10′ to create the sign characters 70′ in a three dimension manner.

The base housing 90′, which is mounted to the attachment side 12′ of the display panel 10′, comprises a backlight arrangement for providing the light towards the display panel 10′, wherein the base housing 90′ has one or more boundary openings 901′ aligned with the contour openings 15′ of the display panel 10′ respectively to form a skeleton of the character signs 70′.

Accordingly, a conventional neon sign comprises an elongated glass tube bent to form the character sign such that the spaces are formed within the character sign. In other words, the spaces are the areas that allow the conventional neon sign to be seen through from one side to another side. The simulated neon illumination sign of the present invention simulates the skeleton of the conventional neon sign by configuring the contour opening 15′ of the display panel 10′ to align with the boundary openings 901′ of the base housing 90′ to form the skeleton of the character sign 70′ as shown in FIG. 8.

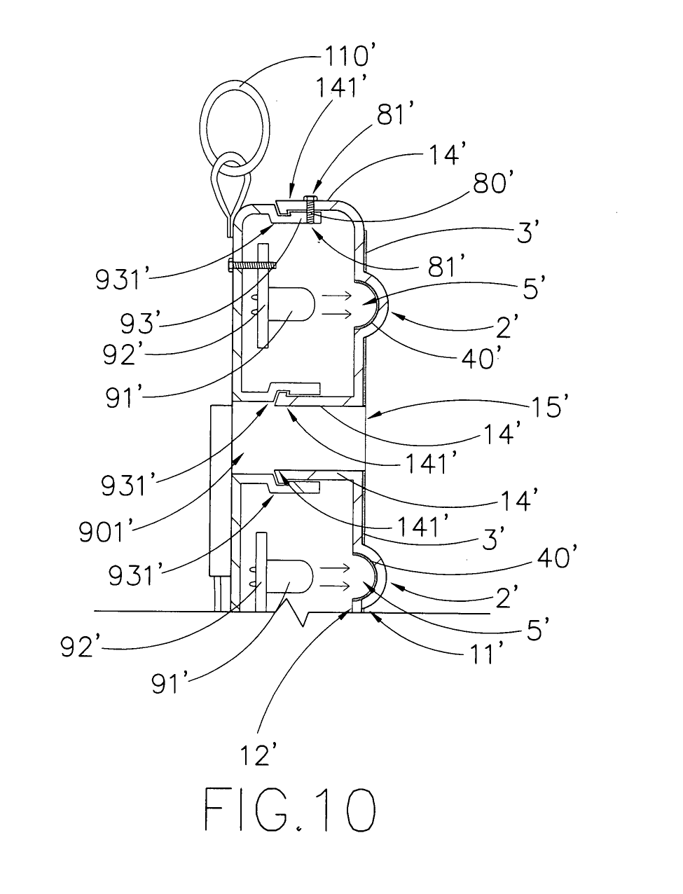

Referring to FIGS. 8 and 9, the display panel 10′ and the base housing 90′ both made of light weight but durable material such as plastic. The display panel 10′ is made of light transmitting materials, The background portion 1′ of the display panel 10′ is preferably a flat surface and the protruding portion 2′ is protruded from the displaying side 11′ to form sign characters 70′. The display panel 10′ further comprises a light blocking layer 3′ coated to the background portion 1′ of the display panel 10′ at the displaying side 11′ thereof for blocking the light penetrating therethrough.

The background portion 1′ of the display panel 10′ is coated with the black color blocking layer 3′ so that the light can not go through the background portion 1′ and the protruding portion 2′ of the displaying side of the display panel 10′ forms sign characters 70′. Applied to all embodiments in the present invention, the black color blocking layer 3′ can be formed by spreading black paint to the light-inadmissible areas based on the design.

According to the preferred embodiment, the display panel 10′, having a uniform thickness, further has a plurality of channels 5′ indently formed at the attachment side 12′ of the display panel 10′ to correspondingly form the protruding portions 2′ at the displaying side 11′, wherein a shape of each of the channels 5′ constitutes a contour of the corresponding character sign 70′.

As shown in FIG. 10, highlighting element 40′ comprises a highlighting coating coated on the attachment side 12′ of the display panel 10′. The highlighting coating comprises an ultraviolet phosphorus coating. The ultraviolet phosphorus coating is on the channel 5′ of the attachment side 12′ of the display panel 10′.

As shown in FIGS. 9 to 11, the base housing 90′ houses the backlight arrangement therein and electrically connects to a power source. The backlight arrangement a circuit board 92′ which is shaped to have a contour corresponding to the skeleton of the character signs 70′ and is supported in the base housing 90′, and a plurality of spaced apart light source which are electrically connected to the circuit board 92′ for generating the light towards the display panel 10′. The light source can be a plurality of LEDs 91, or conventional fluorescent light tubes to generate the light towards the attachment side 12′ of the display panel 10′. For LED configuration, the circuit board 92′ is required to electrically connect and support the LEDs 91′ in the base housing 10′. In addition, the LEDs 91′ are aligned with the channel 5′ of the attachment side 12′ of the sign characters 70′. It is worth mentioning that the light diffusion does not simply reply on the color of the LEDs 91′ in the base housing 90′, but also fine tuned by the ultraviolet phosphorus coating process to achieve all spectrums of colors in current neon signs. In other words, each of the LEDs 91′ generates the light with a wave length matching an ultraviolet wave length of the ultraviolet ray phosphor coating on the display panel 10′.

It is worth to mention that when the display panel 10′ is mounted to the base housing 90′ to align the contour openings 15′ with boundary openings 901′, the through openings are formed. The through openings are designed to create inner boundaries and a wide variety of three dimensional features which are more outstanding than that in conventional neon illumination signs. More specifically, the sign characters 70′ appear more standing out when located at the displaying side 11′ defined by the inner boundaries and the outer boundaries which is the shape of the illumination sign. By creating one or more through openings in the illumination sign, the sign characters 70′ on the display panel 10′ appear more artistic and vivid, and the aesthetic value of the illumination sign is thus increased. Moreover, the sign characters 70′ will not be limited to the manufacturing processes because by placing the through openings in different places of the illumination sign, the feature designers have more degree of freedom to create the sign characters close to their desires. From the environmental point of view, the preferred embodiment in the present invention with through openings on the illumination sign consumes less plastic materials which are harmful to the environment because the plastic materials can take hundreds of years to break down. As they break down, they release poisonous materials into the water and soil. Thus, consuming less plastic materials is the current trend to protect our environment.

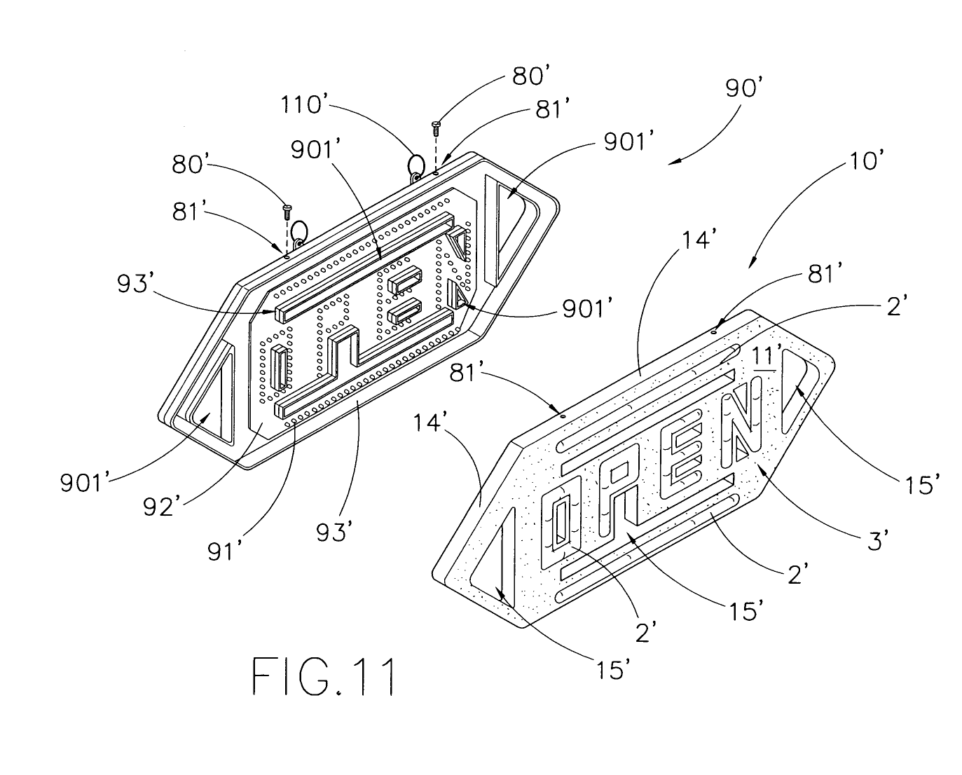

The display panel 10′ and base housing 90′ are both made by plastics and can be firmly snap fit. The LEDs 91′ and the circuit board 92′ are protected from falling apart by a seamless engagement between the display panel 10′ and base housing 90′. As can be seen in FIG. 10 and FIG. 11, the display panel 10′ and base housing 90′ can be seamlessly engaged by using adhesive glue or screws 80′ in multiple engaging edges. As mentioned previously, the display panel 10′ and base housing 90′ are designed to be snap fit. After engaging with each other, adhesive glue is applied on the engaging edges of both panels and a seamless engagement is thus formed.

According to the preferred embodiment, the display panel 10′ forms a front housing having a plurality of engaging rims 14′ extending from peripheral edges of the display panel 10′ and the contour openings 15′ to detachably engage with surrounding rims 93′ of the base housing 90′. Each of the engaging rims 14′ has a first snap hook 141′ integrally formed therealong, wherein each of the surrounding rims 93′ has a second snap hook 931′ which is integrally formed therealong and is interlocked with the first snap hook 414′ of the respective engaging rim 14′ to securely engage the display panel 10′ with the base housing 90′ through the snap fit engagement configuration.

In a preferred embodiment, a plurality of through holes 81′ for screws 80′ are located on the engaging rims 14′ of the display panel 10′ and the surrounding rim 93′ of the base housing 90′ in which the through holes are aligned. The display panel 10′ and base housing 90′ are engaged seamlessly when the screws are tightened. In addition, two hanging rings 110′ are located at the base housing 90′ so that when the display panel 10′ and base housing 90′ are engaged with each other, the illumination sign can be hung to display the neon simulated illumination sign characters thereon.

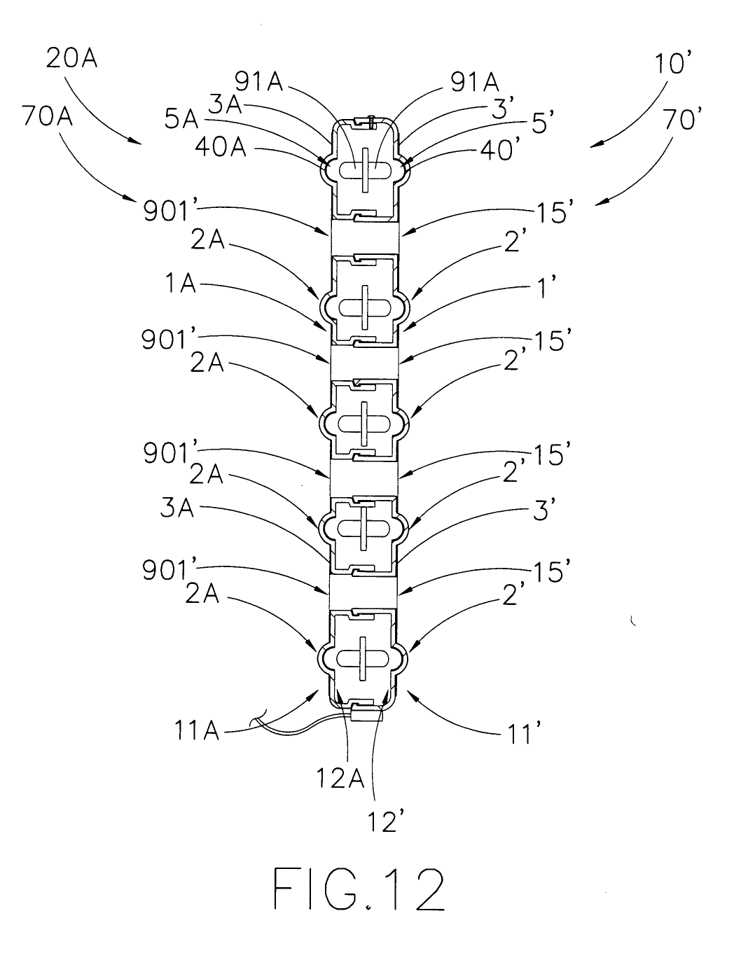

Alternatively, the sign characters 70′ can be seen on both sides. As shown in FIG. 12, this alternative mode comprises two display panels 10′ and 10A, and a base housing 90A. Like the display panel 10′, the second display panel 10A has a displaying side 11A and an attachment side 12A, wherein the display panel 10A comprises a background portion 1A that is preferably a flat surface and a protruding portion 2A that forms sign characters 70A, wherein a light blocking layer 3A is coated to the background portion 1A of the display panel 10A, a highlighting element 40A, a highlighting coating coated on the protruding portion 2A of the attachment side of the display panel 10A. It is worth to mention that the second display panel 10A can be integrally formed at the rear side of the sign housing 90A as shown in FIG. 12. Alternatively, the second display panel 10A can be configured as the first display panel 10′ to detachably mount to the base housing 90A.

The highlighting coating 5A comprises an ultraviolet phosphorus coating. The ultraviolet phosphorus coating is on the channel 5A of the attachment side 12A of the display panel 10A. It is worth mentioning that the light diffusion does not simply reply on the color of the LEDs 91A in the base housing 90A, but also fine tuned by the ultraviolet phosphorus coating process to achieve all spectrums of colors in current neon signs.

The background portion 1A of the display panel 10A is coated with the black color blocking layer 3A so that the light can not go through the background portion 1A and the protruding portion 2A of the displaying side of the display panel 10A forms sign characters 70A. Applied to all embodiments in the present invention, the black color blocking layer can be formed by spreading black paint to the light-inadmissible areas based on the design. Accordingly, the sign character 70A at the second display panel 10A is shaped corresponding to the sign character 70′ at the first display panel 10′ wherein the sign character 70A at the second display panel 10A is a reverse image of the sign character 70′ at the first display panel 10′.

The base housing 90A houses the backlight arrangement therein and electrically connects to a power source. The backlight arrangement a circuit board 92A which is shaped to have a contour corresponding to the skeleton of the character signs 70′, 70A and is supported in the base housing 90A, and a plurality of spaced apart light source which are electrically connected to the circuit board 92A for generating the light towards the display panels 10′, 10A. The light source can be a plurality of LEDs 91A, or conventional fluorescent light tubes to generate the light towards the attachment side 12′, 12A of the display panel 10′, 10A.

As shown in FIG. 12, the LEDs 91A can be mounted on two opposed sides of the circuit board 92A to align with the channels 5′, 5A of the display panels 10′, 10A for emitting the lights thereto. Alternatively, two overlapped circuit boards can be supported in the base housing 90A to mount the LEDs 91A respectively for emitting the lights towards the display panels 10′, 10A.

The practical purpose of the present invention is to provide an alternative to conventional neon signs in terms of performance. Yet the present invention is made of light materials and utilizes diodes as a light source. As a result, the illumination sign of the present invention enjoys low transportation cost and energy consumption as additional advantages.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An illumination sign, comprising:
a display panel having an attachment side, an opposed displaying side, a background portion for blocking light passing through display panel from said attachment side to said displaying side, one or more contour openings spacedly formed at said background portion for communicating said attachment side with said displaying side, and a plurality of protruding portions protruded from said displaying side to form a corresponding number of character signs at said displaying side, wherein said protruding portions is adapted for said light passing through display panel from said attachment side to said displaying side,
a base housing, which is mounted to said attachment side of said display panel, comprising a backlight arrangement for providing said light towards said display panel, wherein said base housing has one or more boundary openings aligned with said contour openings of said display panel respectively to form a skeleton of said character signs; and
a highlighting element provided at each of said protruding portions of said display panel and arranged in such a manner that when said light passes through said protruding portions of said display panel, said highlighting element creates a neon illuminating effect at said protruding portions thereof, such that the character signs are illuminated at said displaying side of said display panel through said protruding portions for simulating a three dimensional neon illumination effect.

2. The illumination sign, as recited in claim 1, wherein said display panel further comprises a light blocking layer coated on said displaying side of said display panel at said background portion for blocking said light penetrating therethrough.

3. The illumination sign, as recited in claim 1, wherein the highlighting element is ultraviolet ray phosphor coating coated on said attachment side of said display panel.

4. The illumination sign, as recited in claim 2, wherein the highlighting element is ultraviolet ray phosphor coating coated on said attachment side of said display panel.

5. The illumination sign, as recited in claim 1, wherein said display panel, having a uniform thickness, further has a plurality of channels indently formed at said attachment side of said display panel to correspondingly form said protruding portions at said front displaying side, wherein a shape of each of said channels constitutes a contour of said corresponding character sign.

6. The illumination sign, as recited in claim 4, wherein said display panel, having a uniform thickness, further has a plurality of channels indently formed at said attachment side of said display panel to correspondingly form said protruding portions at said front displaying side, wherein a shape of each of said channels constitutes a contour of said corresponding character sign.

7. The illumination sign, as recited in claim 1, wherein said backlight arrangement a circuit board which is shaped to have a contour corresponding to said skeleton of said character signs and is supported in said base housing, and a plurality of spaced apart LEDs which are electrically connected to said circuit board for generating said light towards said display panel.

8. The illumination sign, as recited in claim 4, wherein said backlight arrangement a circuit board which is shaped to have a contour corresponding to said skeleton of said character signs and is supported in said base housing, and a plurality of spaced apart LEDs which are electrically connected to said circuit board for generating said light towards said display panel.

9. The illumination sign, as recited in claim 6, wherein said backlight arrangement a circuit board which is shaped to have a contour corresponding to said skeleton of said character signs and is supported in said base housing, and a plurality of spaced apart LEDs which are electrically connected to said circuit board for generating said light towards said display panel.

10. The illumination sign, as recited in claim 7, wherein each of said LEDs generates said light with a wave length matching an ultraviolet wave length of said ultraviolet ray phosphor coating on said display panel.

11. The illumination sign, as recited in claim 8, wherein each of said LEDs generates said light with a wave length matching an ultraviolet wave length of said ultraviolet ray phosphor coating on said display panel.

12. The illumination sign, as recited in claim 9, wherein each of said LEDs generates said light with a wave length matching an ultraviolet wave length of said ultraviolet ray phosphor coating on said display panel.

13. The illumination sign, as recited in claim 1, wherein said display panel forms a front housing having a plurality of engaging rims extending from peripheral edges of said display panel and said contour openings to detachably engage with surrounding rims of said base housing.

14. The illumination sign, as recited in claim 6, wherein said display panel forms a front housing having a plurality of engaging rims extending from peripheral edges of said display panel and said contour openings to detachably engage with surrounding rims of said base housing.

15. The illumination sign, as recited in claim 12, wherein said display panel forms a front housing having a plurality of engaging rims extending from peripheral edges of said display panel and said contour openings to detachably engage with surrounding rims of said base housing.

16. The illumination sign, as recited in claim 13, wherein each of said engaging rims has a first snap hook integrally formed therealong, wherein each of said surrounding rims has a second snap hook which is integrally formed therealong and is interlocked with said first snap hook of said respective engaging rim to securely engage said display panel with said base housing.

17. The illumination sign, as recited in claim 14, wherein each of said engaging rims has a first snap hook integrally formed therealong, wherein each of said surrounding rims has a second snap hook which is integrally formed therealong and is interlocked with said first snap hook of said respective engaging rim to securely engage said display panel with said base housing.

18. The illumination sign, as recited in claim 15, wherein each of said engaging rims has a first snap hook integrally formed therealong, wherein each of said surrounding rims has a second snap hook which is integrally formed therealong and is interlocked with said first snap hook of said respective engaging rim to securely engage said display panel with said base housing.

19. The illumination sign, as recited in claim 1, wherein each of said protruding portions of said display panel has a curved cross section integrally protruding from said background portion of said displaying side of said display panel to create said sign characters in a three dimension manner.

20. The illumination sign, as recited in claim 18, wherein each of said protruding portions of said display panel has a curved cross section integrally protruding from said background portion of said displaying side of said display panel to create said sign characters in a three dimension manner.
